(19) United States
(12) Patent Application Publication
(10) Pub. No.: US 2009/0115194 A1
(43) Pub. Date: May 7, 2009

(54) Breeze-type wind energy generator

(76) Inventor: Ying-Lang Lin, Taipei City (TW)

Correspondence Address: Ying-Lang Lin, P.O. BOX NO. 84-518, Taipei, TW

(21) Appl. No.: 11/899,531

(22) Filed: Sep. 7, 2007

(51) Int. Cl. F03D 9/00; F03D 3/02

(52) U.S. Cl. 290/55; 416/174; 416/244 R

(57) ABSTRACT

The present invention comprises a very wide & high square or octagon or circular steel bar base frame having a very wide & high hollow interior and many very wide opening sides allowing the wind to blow into the hollow interior, a vertical-type very long shaft vertical at a central portion of the hollow interior, many layers of a horizontal-type blade rotor formed comprises several or more horizontal & erect-type rectangle or strip or wall-type blades applying to overall to face to the wind and to be blown directly by the wind, and formed to rotate by a horizontal-type, and formed installed coaxially with the very long shaft and installed inside the hollow interior, an electrical generator or a power transmition device applying transmition out a power come from the very long shaft, and an electrical stabilize related system etc., whereby the electrical generator or the power transmition device is able to generate its function when the wind is blow the many layers of the horizontal-type blade rotor.

### BACKGROUND OF THE INVENTION

(1) Field of the Invention

The present invention relates to wind energy generator, particular to, a breeze-type wind energy generator generating the wind energy by many layers of a horizontal-type blade rotor rotating by a horizontal-type and rotating inside a very wide & high hollow interior of a very wide & high square or octagon steel bar base frame having many wide opening sides/periphery then to generate an electricity or a power when blown by the wind.

(2) Description of the Prior Art

The current conventional wind energy generator (windmill) its efficiency generating an electricity is very low, this defect not solve to nowadays and a main cause at its blades are cannot overall to face the wind to be blown and are to be blown only from a side of each of the blades by an askew fricatived force fricatived when the wind to pass the blades.

Nowadays, to get the sea water to become the fresh water is requiring to expend many electricitys to pump up the sea water so a cost of the fresh water is very high.

Because of this two defects as above, so the inventor going providing the present invention to respectively solve.

### SUMMARY OF THE INVENTION

First purpose of the present invention provides the breeze-type wind energy generator to generate a powerfuler electricity powerfuler than that of the current conventional wind energy generator, even to generate a double electricity higher than the current conventional wind energy generator.

Second purpose of the present invention provides the breeze-type wind energy generator to generate the power to drive a pump then to pump the sea waters and to provide producing the fresh waters, or even to provide apply at any necessary power which is requiring only a power with a torsionss & rotating speed and requiring no an electricity.

### BRIEF DESCRIPTION OF THE DRAWINGS

FIG. 1 is a bird's-eye of the breeze-type wind energy generator of the present invention.

FIG. 2 is a front view of the breeze-type wind energy generator of the present invention.

FIG. 3 is a side view of a very wide & high steel bar base frame of the breeze-type wind energy generator.

FIG. 4 is a front view of one layer of the many layers of the horizontal-type blade rotor of the breeze-type wind energy generator. The one layer withs four a horizontal & erect-type rectangle blades arranged formed a cross.

FIG. 5 is a side view of a vertical-type very long shaft.

FIG. 5A is a side view fragmentary of another structure of the vertical-type very long shaft.

FIG. 6 is a front view of the one layer of the many layers of the horizontal-type blader rotor. The one layer withs eight the horizontal & erect-type rectangle blades arranged formed a spokewise shaped and onjoined together by eight or more conjoining cross beams respectviely conjioned at between each of the eight horizontal & erect-type rectangle blades.

FIG. 7 is a front view of an erect-type arc blade providing for replacing the horizontal & erect-type rectangle blade.

FIGS. 8,9 are a front view of a foundation of the very wide & high steel bar base frame.

FIG. 10 is a bird's-eye of anther embodiment of the breeze-type wind energy generator with a very wide & high octagon steel bar base frame and eight the horizontal & erect-type rectangle blades, which are connected no the eight conjoining cross beams.

FIG. 11 is a side view of the octagon steel bar base frame.

FIG. 12 is a side view of a wall-type blade providing for replacing the horizontal & erect-type rectangle blade.

FIG. 13 is a bird's-eye of the horizontal-type blade rotor with three the horizontal & erect-type rectangle blades.

FIG. 14 is a side view of fragmentary of the rectangle blade.

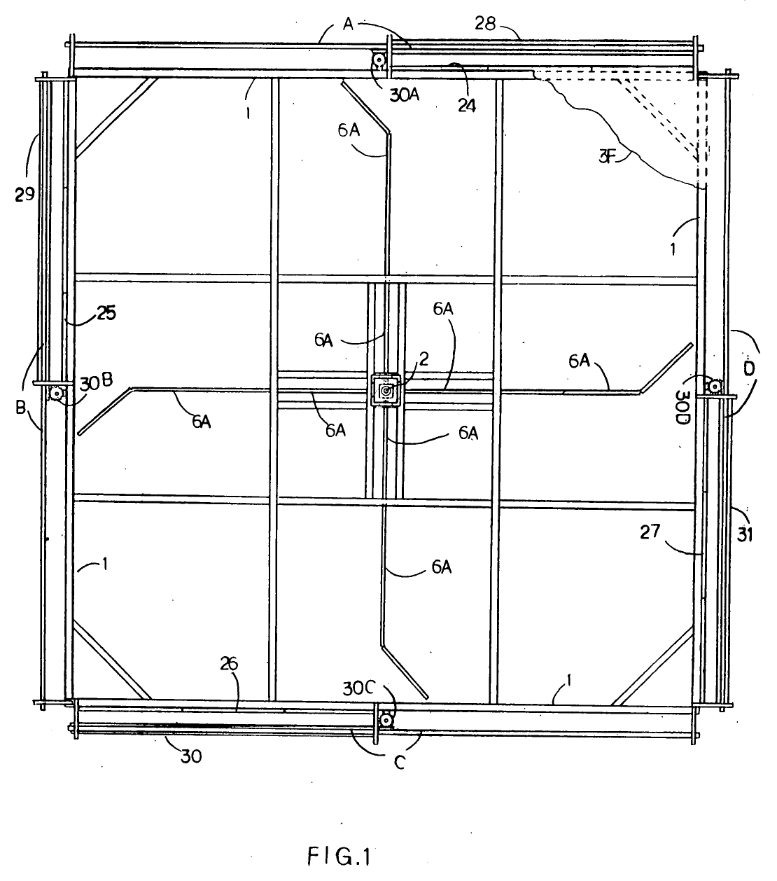

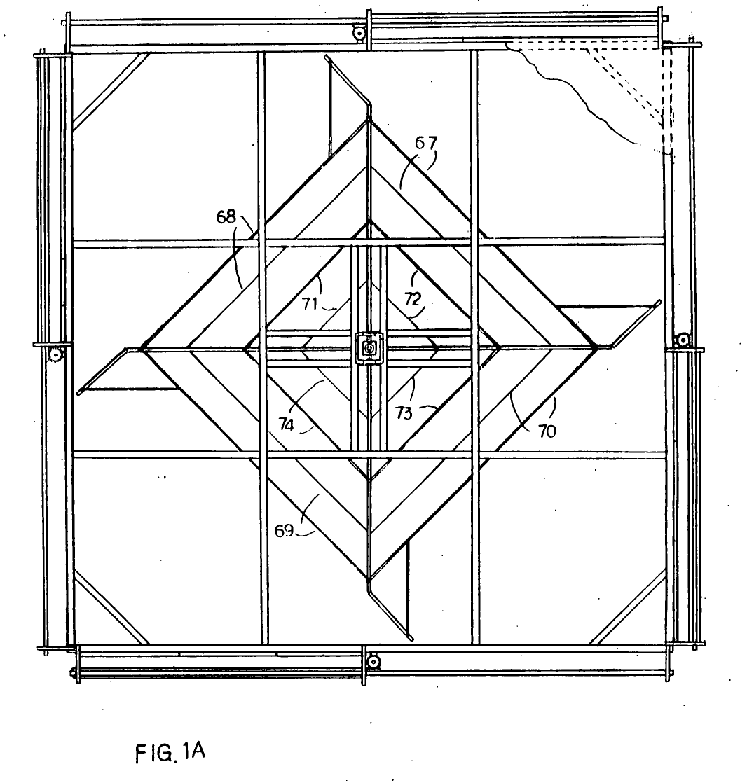

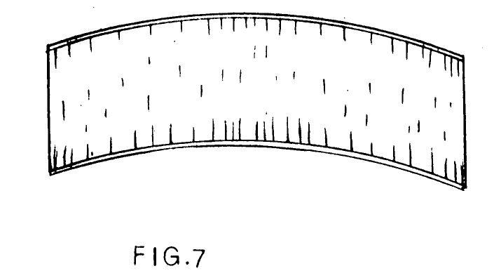

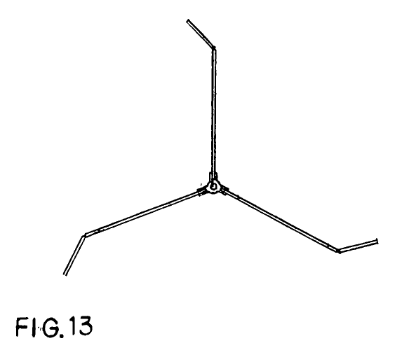

The FIGS. 1-14 are no according to a proportion of the breeze-type wind energy generator, so the applicant is will to amend.

### DESCRIPTION OF THE INVENTION

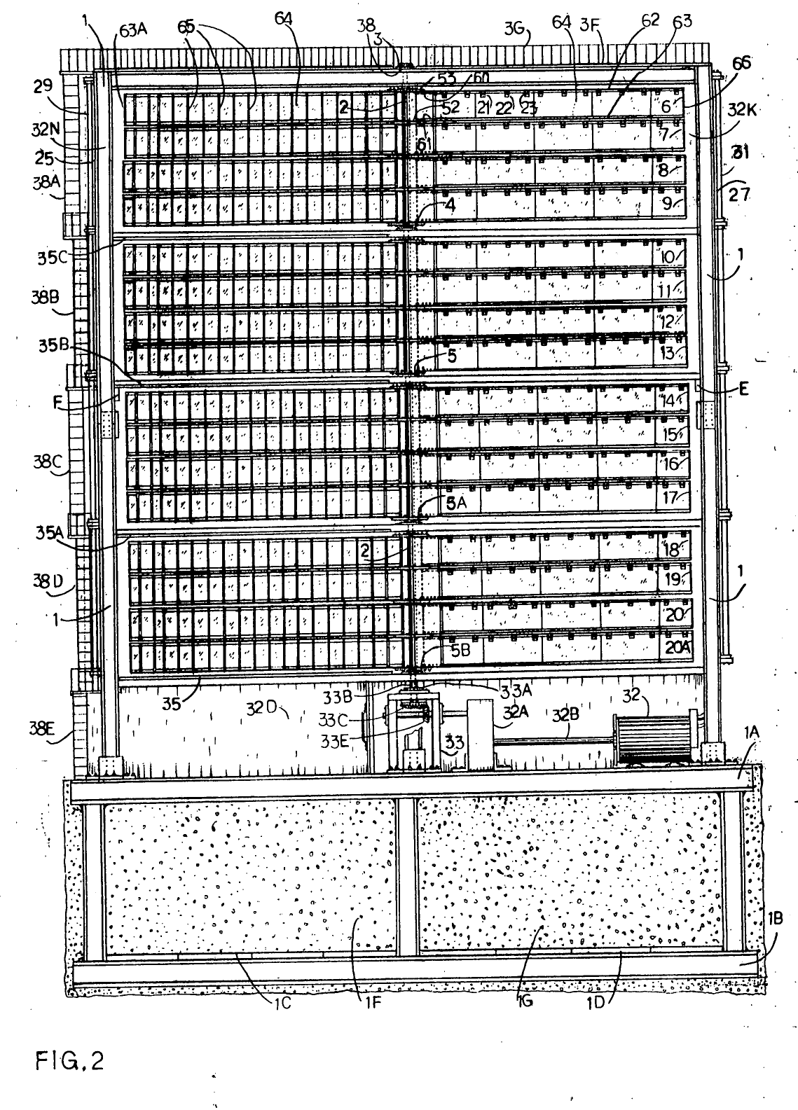

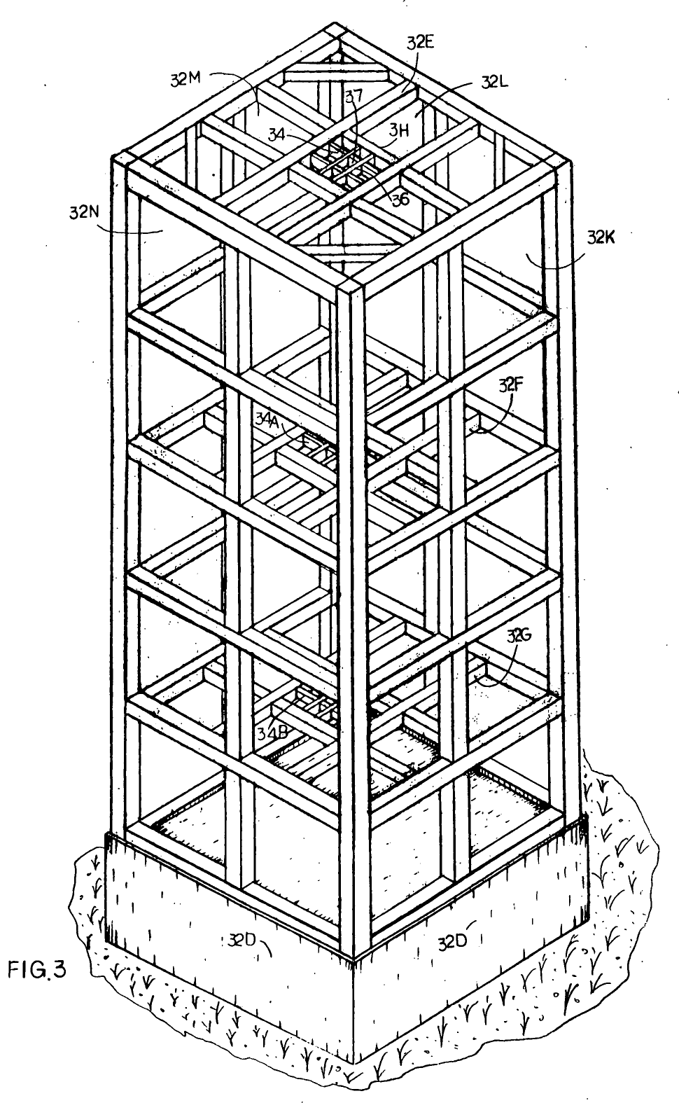

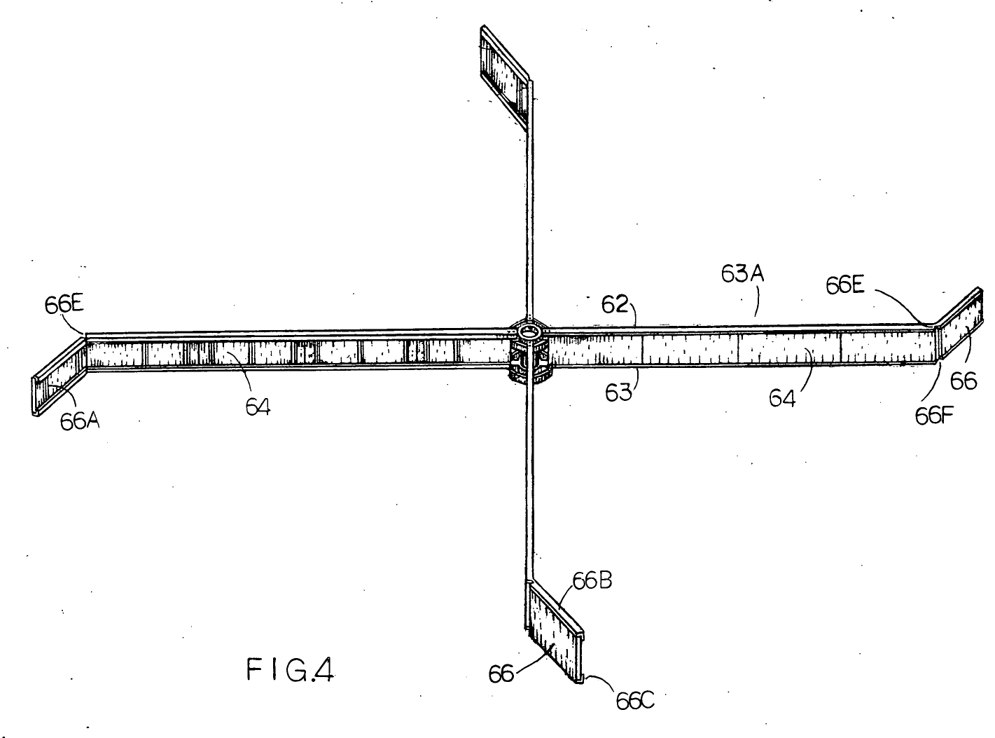

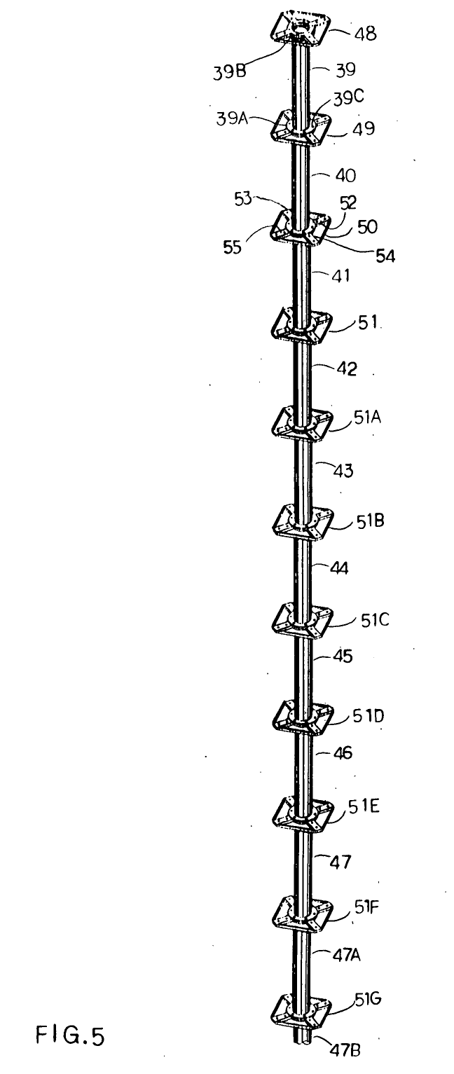

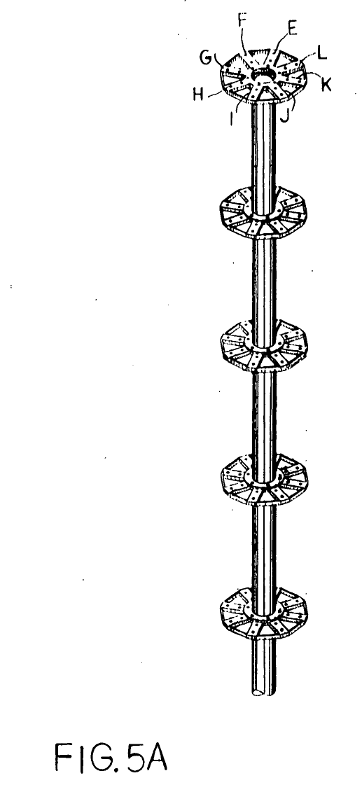

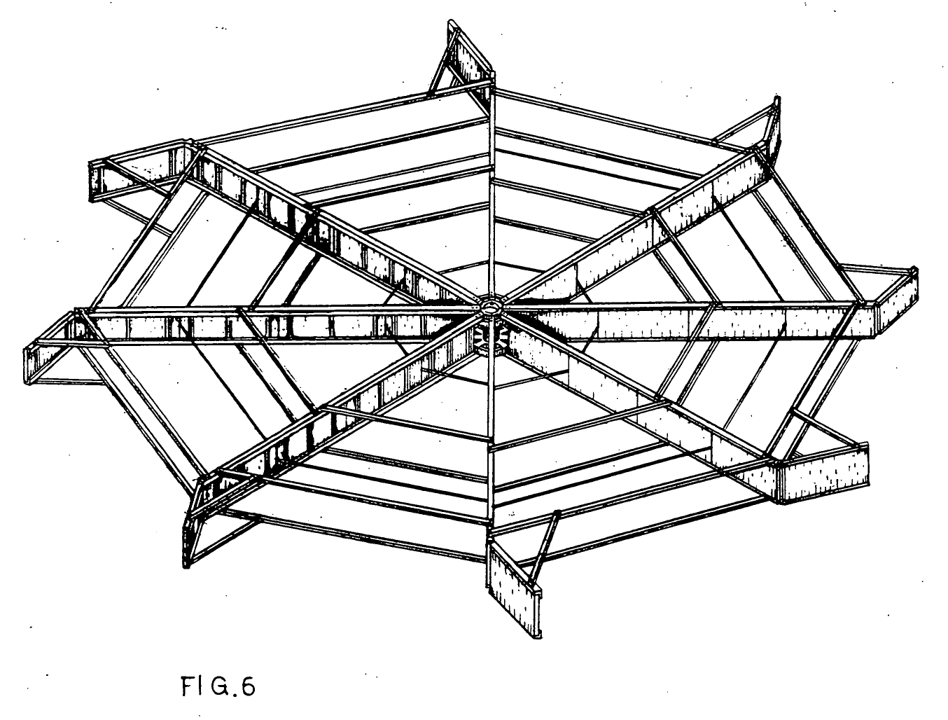

The breeze-type wind energy generator of the present invention (thereinafter abbreviate call the present invention) as shown in FIGS. 1,2, it is rotation by a vertical-type shaft and not horizontal-type shaft as that of the current conventional wind energy generator (thereinafter abbreviate call the current wind energy) and is no require the great high tower and great blade rotor as that of the current wind energy, and it is constituted comprise a very wide & high square steel bar base frame FIG. 3, FIG. 2 No. 1 (thereinafter abbreviate call the wide base frame) having a very wide & high hollow interior and many very wide opening sides (periphery), a vertical-type very long shaft FIG. 2, FIG. 5 No. 2 (thereinafter abbreviate call the very long shaft) vertical at a central portion of the very wide & high hollow interior of the wide base frame, two or more bearing devices (for example FIG. 2 No. 3,4, 5,5A,5B) applying fix and stabilize the very long shaft by a rotatable way, several or more layers of a horizontal-type blade rotor FIGS. 1,10 No. 6A (thereinafter abbreviated call the many horizontal blade rotors) respectively with four FIG. 4 (or six) or eight FIG. 6 horizortal & erect-type rectangle blade members FIG. 2 No. 6,7,8, 9,10,11,12,13,14,15,16,17,18,19,20,20A (thereinafter abbreviate call the horizontal blades) arranging by a cross or spokewise shaped, a resistance reduction and torsion strengthen device (for example FIG. 2 No. 21,22,23) applying reduction the resistance of wind when each of the many horizontal rotors is rotation, a torsion promotion & one-way rotation device FIG. 1 No. 24,25,26,27, a rotational speed controll device FIG. 1 No. 28,29,30,31 applying to control a rotational speed of the many horizontal blade rotors, an electrical generator FIG. 2 No. 32 or a power transmition device applying transmition out a power come from the very long shaft to provide using, an electrical stabilize related system applying stabilize an electricity generating from the electrical generator, and an engine room FIGS. 2,3 No. 32D inside a under layer of the wide base frame etc.

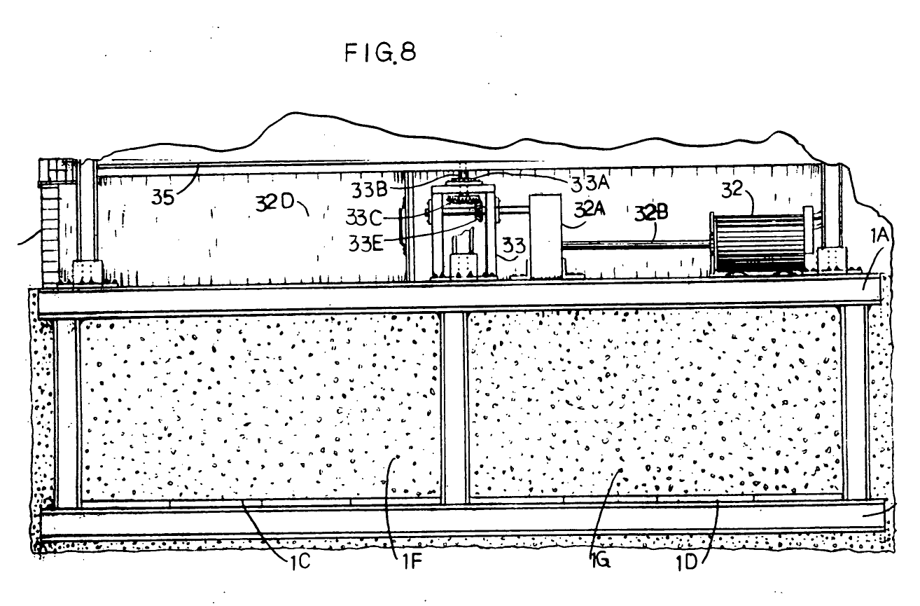

The wide base frame FIG. 3 is builded formed by a way & the steel bars like that of building a big storied building, and is builded formed a square or octagon or circular or polygon steel bar, and is builded formed further comprise several or more layers which namely separateds, the very wide opening sides which namely the periphery (for example FIG. 3 No. 32K,32L,32M,32N, FIG. 2 No. 32K,32N) of the wide base frame and which are respectively apply to be opened or closed and to allow the wind to blow the many horizontal blade rotors to rotate, the very wind & high hollow interior applys install the many horizontal blade rotors and install two or more bearing frames, a very stable foundation having two or more layers of a wide & thick weight FIG. 2 No. 1A,1B respectively builded formed by many H-shaped steel bars and thick steel sheets FIG. 2 No. 1C,1D or by a reinforced concrete FIG. 8 No. 1K,1L and havung be infilled the original sandy soils 1F,1G which are dug up at before building the very stable foundation to between the two layers or each of the more layers and to make the very stable foundation to become more weigh & stable, a roof FIGS. 1,2 No. 3F, and a protect railing FIG. 2 No. 3G on its cockloft periphery and several conductors etc. The steel bars are respectively of a H-shaped steel bar or square pipe steel bar. The several or more layers which namely separateds (spaceds) are respectively formed by several or more joining subsidiary frames (separaters) FIG. 3 No. 32E,32F,32G respectively separated distributed at several or more sections of the wide & high hollow interior of the wide base frame and respectively joined with a periphery inside each of the sevaral or more sections. The several or more joining subsidiary frames 32E,32F,32G are respectively assembled to into nine or more square frames which are include a ceneral square frame (for example FIG. 3 No. 3H) and assembled by four or more cross beams which are mutualy cross and are respectively to join with the periphery of each of the several sections and to distribute at between a lower and upper portion of the wide & high hollow interior of the wide base frame and to make the wide & high hollow interior of the wide base frame to be separated to into the several or more layers, thereby to enhance a strong structure of the wide base frame and to provid for joining mount the two or more bearing devices. The many H-shaped steel bars and the many thick steel sheets are with a prevent-rust effect. The very stable foundation its deep is at about ⅓ of a height of the wide base frame or more deep at a necessary situation.

The wide base frame FIG. 3 its height and width are can be decided at accorde a necessary situation, for example height at 24-48 meters or more high, width at 10-24 meters or more wide.

A central portion of a surface of the very stable foundation of the wide base frame withs an erect bearing base FIG. 2 No. 33 applying mounting a ball collar thrust bearing (a plane bearing, for example FIG. 2 No. 33A) which is applying to bear a thrust and to support an under end of the very long shaft 2.

The wide base frame further comprises the two or more bearing frames (for example FIG. 3 No. 34,34A,34B) and several or more work stations FIG. 2 No. 35,35A,35B,35C respectively attached on each of the several or more joining subsidiary frames 32E,32F,32G. The two or more bearing frames 34,34A,34B are respectively combined formed on wherein each of the several or more joining subsidiary frames 32E,32F,32G so are respectively distribution at between a lower and upper portion of the very wide & high hollow interior or at between a lower and upper portion of the wide base frame.

The two or more bearing device (FIG. 2 No. 3,4,5,5A,5B) are respectively assembled comprise the two or more bearing frames 34, 34A,34B. The two or more bearing frames are respectively formed by four short cross beams (for example FIG. 3 No. 36) mutually cross way as that of each of the four or more joining subsidiary frames and respectively formed at a central square frame (for example FIG. 3 No. 3H) of each of the several or more joining subsidiary frames and respectively formed with a small central square frame (for example FIG. 3 No. 37) smaller than the central square frame 3H. The small central square frame 3H provides for a trough bearing base (for example FIG. 2 No. 38) to inlay thereto. The trough bearing base withs a flange on its periphery of trough mouth for be mounted on the each bearing frame. Each of the four short cross beams 36 is connected from a side of the central square frame 3H and connected by two ends of each of the four short cross beams.

The wide base frame further comprises several or more steps of a staircase FIG. 2 No. 38A,38B,38C,38D,38E on an outside of one of four sides of the wide base frame and respectively providing for a worker to reach the several or more work stations FIG. 3 No.35,35A,35B,35C.

The very long shaft 2 is vertical at a central portion of the very wide & high hollow interior of the wide base frame and is providing for coaxially installing the many horizontal blade rotors, and is rotatably fixed and vertical at the central portion from the lower to upper portion of the wdie base frame, and is connected formed by several or more of a short metallic piping members (for example FIG. 5 No. 39,40,41,42,43,44,45,46,47,47A,47B) respectively with a flange (for example FIG. 5 No. 39A,39B) on its two ends and with several holes (for example FIG. 5 No. 39C) on the flange, and is connected formed with several or more thick metallic connecting hub members (for example FIG. 5 No. 48,49,50,51,51A,51B,51C,51D,51F,51G) respectively at between each of the several or more short metallic piping members 39,40,41,42,43,44,45,46,47,47A,47B and respectively withs four thick metallic connectors (for example FIG. 5 No. 52,53,54,55) or six or eight thick metallic connectors (FIG. 5A No. E,F,G,H,I,J,K,L).

The very long shaft is length at about 24 meters or more long, and is its lower end portion FIG. 2 No. 33B be mounted on the erect bearing base (FIG. 2 No. 33) so be kept on an appropriate distance with a surface of the very stable foundation FIG. 2 No. 1A so as to provide for installing a group of bevel wheels/gears (for example FIG. 2 No. 33C,33E) applying change a rotational direction and speed of the very long shaft then to drive the gear box 32A of the power transmitting device. The lenght of the very long shaft is can be decided at accorde a necessary situation as that of the wide base frame.

The several or more thick metallic connectors 52,53,54,55 are respectively extended from each of the several or more thick metallic connecting hubs 48,49,50,51 and are together be arranged into a horizontal cross or spokewise shaped and are respectively with a plane portion on its upper and under face.

At between each of the several or more thick metallic connectors withs a cross beam (for example FIG. 1 No. 56,57,58,59) which is together to be cast into with each thick metallic connector and is to reinforce the each so as to strengthen the bear force of the each several or more thick metallic connectors.

The many layers of horizontal blade rotors are rotation inside the very wide & high hollow interion of the wide base frame, and are to be distributed on the several or more layers (separateds) of the wide & high hollow interion of the wide base frame by some layers wherein the many layers, and are applying to drive the very long shaft to rotate when blown by the wind, and are arranged combined together to form the many layers at between the lower and upper portion of the wide & high hollow interior and to form the many layers.

The several bearing devices comprises two or more the ball collar thrust bearings and several or more shaft bearings so as to stabilize the very long shaft and to assistance the very long shaft to easily rotation.

The two or more ball collar thrust bearings are respectively to bear the thrusts of two or more sections of the very long shaft. The two or more sections are respectively distinguished from the very long shaft so as to respectively supporting the very long shaft and to partake bear the all thrusts of the very long shaft. At between each of the two or more sections is connected with a square metallic connector so as to make they to together into coaxially.

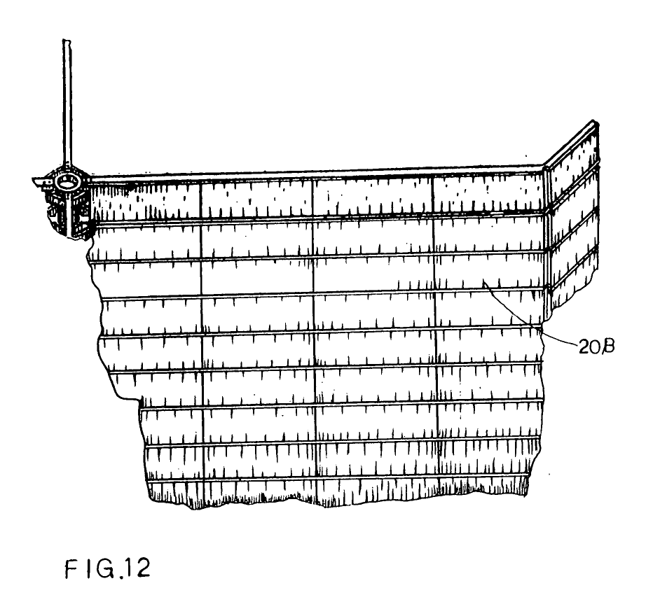

Each horizortal blade of each layer of the many horizontal blade rotors is respectively seem an erect-type rectangle or strip or seem an erect but slightly inclined rectangle or strip or seem a wall-type blade FIG. 12 No. 20B, FIG. 2 No. 6,7,8,9,10,11,12,13,14,15,16,17,18,19,20,20A shaped seem a wide & high wall.

Because the each horizontal blade it is installed at the very long shaft by an erect-type, so it not only able to overall to face to the wind and able to overall and directly to be blown by the wide, and not indirectly to be blown by the wind from a lateral side (an askew side) as that of the current wind energy so able to start at a breeze about 1.5 m/s.

The each horizontal blade is length at about 10-15 meters or even more long at about 35-40 meters as that of the current wind energy grnerator, and is horizontal (laterally) extending outward from a periphery of the very long shaft, and is extending by a way connected at between an upper and under faces of wherein one 52,53 of the four (or six or eight) thick metallic connectors of each of wherein two of the thick metallic connecting hub members (for example FIG. 2 No. 48,49) of the very long shaft, and is connected from one end portion (for example FIG. 2 No. 60,61) of an upper and under portions of each of two very long cross beams like an angle steels (for example FIG. 2,4,14 No. 62,63) of an erect-type rectangle frame (for example FIG. 2,4 No. 63A) which is providing for installing the each horizontal blade. The each horizontal blade its length and height are can be decided at accorde a necessary situation.

The each horizontal blade is formed comprise several or more erect-type rectangle plastic planking members (thereinafter abbreviate call the rectangle plastic planking) or other erect-type rectangle members (for example FIG. 2 No. 64) arranged align from lateral or erect (vertical) arranged, an erect-type rectangle frame provideing for installing the several or more erect-type rectangle plastic planking members, and the saveral hingess (for example FIG. 2 No. 21,22,23) of the resistance reduction and torsion strengthen device.

The erect-type rectangle frame (for example FIG. 2 No. 63A) is formed comprise the two very long cross beams like the angle steel 62,63 or angle aluminum (or two very long square metallic pipes) respectively at an upper and under members of the erect-type rectangle frame, and respectively is apply a main base, and comprise many smaller combining members (for example FIG. 2 No. 65) respectively applys to be separated but together to connect the two very long cross beams like the angle steel to form the erect-type rectangle frame. Each of the many smaller metallic combining members is shaped as that of the each of the two very long cross beam like angle sheet and is combined at between the upper and under members of the erect-type rectangle frame and is mutually kept on an appropriate distance. Due to the structure as above so the erect-type rectangle frame is very strong and unable droop after one end of each of the upper and under members are connectors respectively connected to therein one of the four thick metallic 56,57,58,59. Each of the four thick metallic connectors is very strong so able to bear the each horizontal blade.

The erect-type rectangle frame further comprises two flat cross beam applying respectively be separated and to join the many smaller combining members, if the erect-type rectangle frame is formed to more long & high.

Each of the several or more rectangle plastic plankings is connected fixed on the erect-type rectangle frame by several hingess (for example FIG. 2 No. 21,22,23) from an upper side of the each rectangle plastic planking.

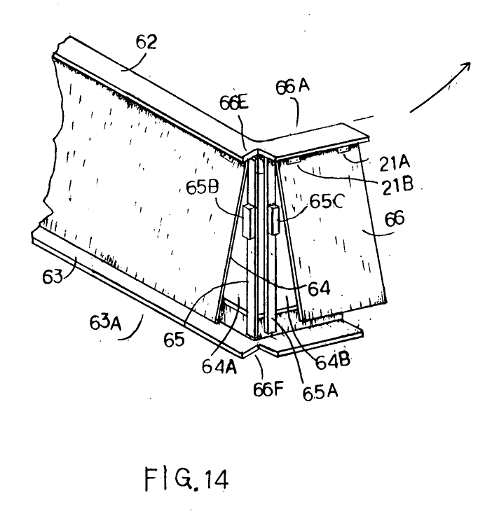

The resistance reduction and torsion strengthen device is formed comprises the saveral hingess (for example FIG. 14 No. 22,23, FIG. 2 No. 21,22,23) and the each rectangle plastic planking (for example FIGS. 2,14 No. 64). The each rectangle plastic planking is fixed by the saveral hingess. The each rectangle plastic planking FIG. 14 No. 66 of the backward awry portion FIGS. 2,4 No. 66 of the outward end portion of the each horizontal blade is fixed by another saveral hingess (for example FIG. 14 No. 21A,21B), whereby the each rectangle plastic planking can to inclined backward turn and turn up from an under side of the each rectangle plastic planking then to become an inclined pose (for example FIG. 14 No. 64,66) when the each rectangle plastic planking is respectively to be blown by the wind and to actuate the horizontal blade rotor to rotate and after the each rectangle plastic planking is not to be blown by the wind and is on return its original place and is to against the wind, and whereby can generate a very long space (for example FIG. 14 No. 64A, 64B) seem a very long triangle and to allow the wind to pass and to reduce a resistance of the each rectangle plastic planking and to strengthen a torsion of the each horizontal blade rotor, but the each rectangle plastic planking is cannot frontward turn to become a frontward inclined pose when the each rectangle plastic planking is favorable the wind and is blown by the wind and to actuate the each horizontal blade rotor to rotate, because the each rectangle plastic planking is stopped by the many small metal combining members (for example FIG. 14 No. 65,65A) of the erect-type rectangle frame. The each erect-type rectangle frame is attached many cushiony rubbers (for example a sponge rubber FIG. 14 No. 65B,65C), thereby to reduce a crash if the each rectangle plastic planking is to collide the erect-type rectangle frame.

The each horizontal blade further comprises a backward awry por- (for example FIGS. 2,4,14 No. 66) at its outward end portion. The backward awry portion is formed comprise a short rectangle frame (for example FIGS. 4,14 No. 66A) shorter than that of the erect-type rectangle frame (FIG. 2,4,14 No. 63A), a short rectangle plastic planking member (for example FIG. 14 No. 66) shorter than that of the each rectangle plastic planking 64, several metallic combining members effecting as that of the several combining members FIG. 2 No. 65, and another resistance reduction and torsion strengthen device FIG. 14 No. 21A,21B,66 effecting as that of the resistance reduction and torsion strengthen device etc., and is formed its upper and under cross beam like the angle steel (for example FIGS. 2,14 No. 66B,66C) are respectively be awry rightward (or leftward) from an appropriate length of an outward end portion of the two very long cross beams like the angle steel (FIG. 14 62,63) of the erect-type rectangle frame and are respectively be awry backward to about 45 degree so can strengthen an efficiency blown by the wind.

The upper and under cross beams like the angle steel are respectively be cut to cause a gap (for example FIG. 4,14 No. 66E,66F) so as to be awry easly from a symmetrical one side of the appropriate length of the upper and under cross beams like the angle steel before not to be awry, because the upper and under cross beams like the angle steel are respectively of the angle steel so bended is very difficult if no be cut on the one side.

The each horizontal blade rotor further comprises several joining cross beams (for example FIG. 1A No. 67,68,69,70,71,72,73,74 respectively joining at between the each horizontal balde, so able to very strong to resist the push force of wind. For special to shown a structure of the each horizontal blade rotor, so the each horizontal blade rotor with the four horizontal blades as shown in the FIG. 4, it no be shown the joining cross beam as the several joining cross beams.

The torsions promotion and one-way rotation device comprises several or more covers (for example FIG. 1,2 No. 24,25,26,27) respectively to cover on each of the many very wide opening sides (periphery, for example FIG. 2 No. 32K 32L,32M,32N) of each of the several or more layers (separateds) of the wide base frame to an extent about ½ from a left or right side of each of the many wide opening sides, thereby to restrict the wind to only blow to about ½ (radius) of a diameter of the each horizontal blade rotor and thereby to avoid generating an offsetting force if when two sides which namely the diameter of the each horizontal blade rotor are together to be blown by the wind and thereby to restrict the each horizontal blade rotor to rotate is only to one-way rotation.

The present invention further comprises the rotational speed controlling device, this comprises many layers of a door (for example FIG. 1 No. 28,29,30,31 respectively on a portion about 50% of each of the many very wide opening sides of the many layers of the wide base frame, four groups of a gear reduction device (for example FIG. 1 No. 30A,30B,30C,30E) respectively applying to drive a rack of central one of the many layers of door of one side of the many very wide opening sides to laterally opening or closing the each door to a certain extent about the 50%, a pair of rail (for example FIG. 1 No. A,B,C,D) respectively on an upper and under side of the each door and respectively providing the each door to slide to open or close, four motors (for example FIG. 2 No. E.F, only shown wherein two of the four) respectively on the each side of the very wide opening sides and respectively applying to actuate each of the four groups of the gear reduction device to drive the rack of the central one door to laterally opening or closing the each door to the certain extent, and four switchs respectively providing to controll each of the four motors to turn or stop. The each door of each of the many layers of the each side of the many very wide opening sides are combined together so as to together to be pushed and to opened or closed by one of the four motors, and the each (for example FIG. 2 No. E) of the four motors is installed on the central one door of the many layers of the doors then to drive the rack.

The rotational speed controlling device provides for to controll the each door to close to the certain extent which is reduction the force of the wind when the wind speed is exceed to a certain extent or when a typhoon is happened, thereby to continuously allowing the wind to cotinuously blow the many horizontal blade rotors and not need to stop turn and to continuously generating the power or the electricity when the wind speed is exceed to the certain extent or the typhoon is happened, and provides for to contrail the each door to close and to stop the wind to blow the many horizontal blade rotors when at a necessary situation.

The power transmition device comprises a gear box FIG. 2 No. 32A which is apply to be driven by an original power come from the very long shaft (FIG. 2 No. 2) then to change a rotational speed of the very long shaft, and is comprise a clutch device applying to control a rotational direction of the power transmition device, and a power transmitting shaft (FIG. 2 No. 32B) applying to be driven by a power generating come from the gear box and applying to drive the electrical generator or to transmit out a power come from the gear box then to provide for using when the many horizontal blades are blown by the wind. The clutch device applys to restrict the power transmitting shaft 32B to rotate is only to one-way rotation so as to match the one-way rotation of the torsions promotion and one-way rotation device.

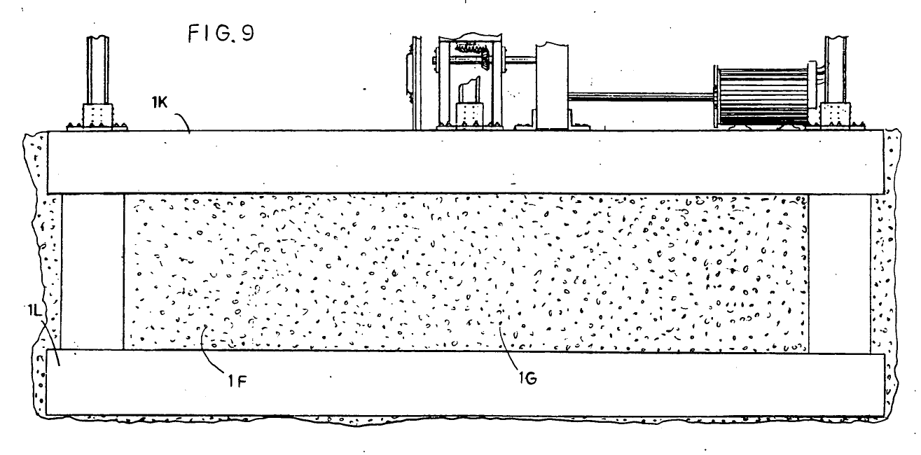

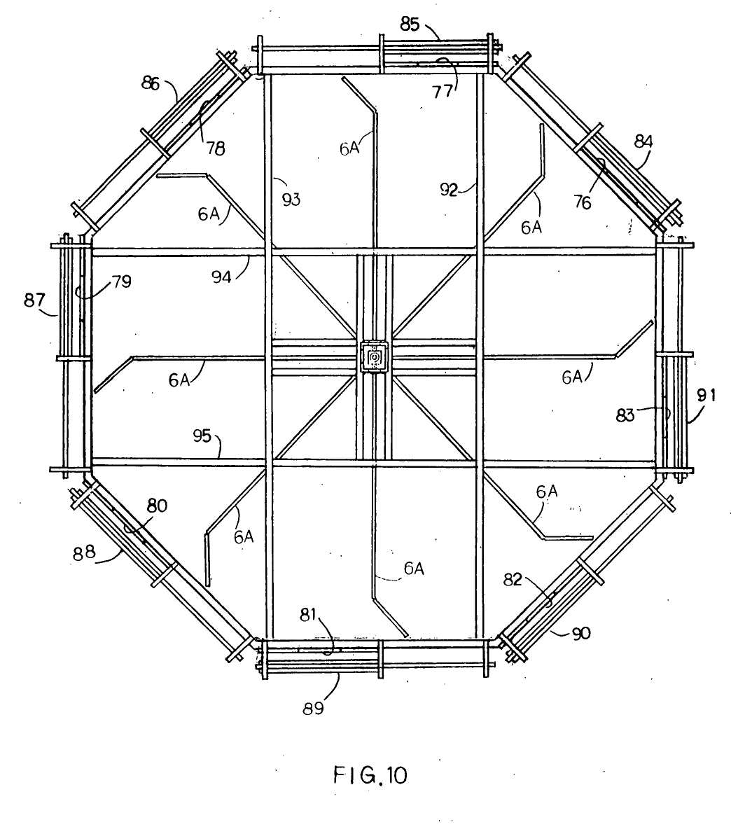

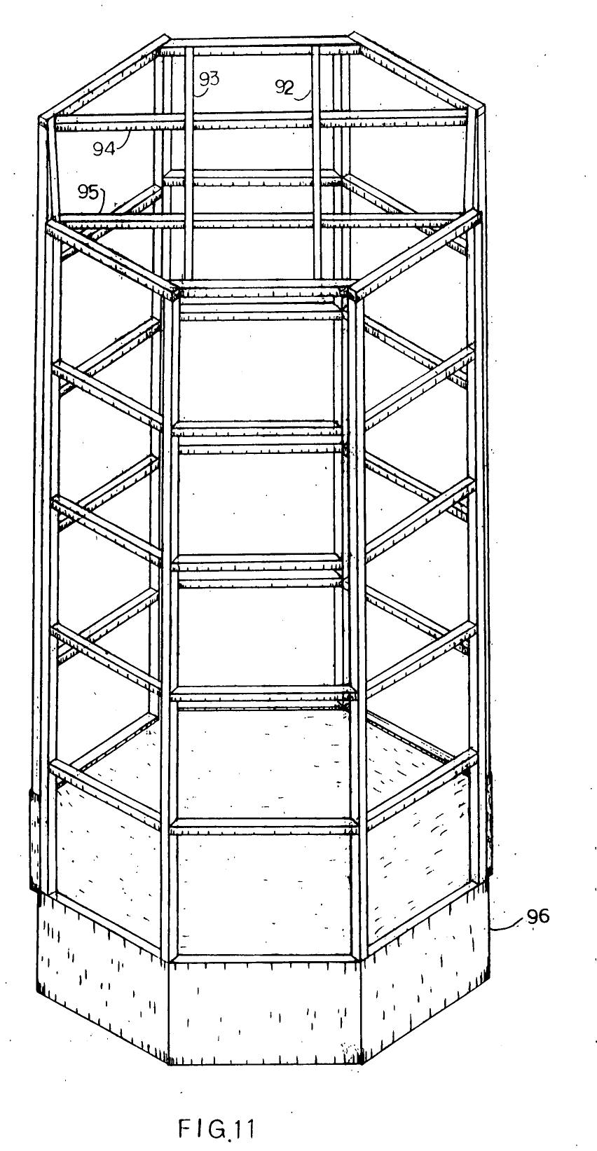

The present invention further provides a very wide & high octagon steel bar base frame as FIG. 10 No. 1, FIG. 11 to replace the wide & high square steel bar base frame which namely the wide base frame FIG. 3. The very wide & high octagon steel bar base frame it withs eight very wide opening sides (a very wide opening periphery) respectively on its each layer and respectively allowing the wind to blow the each layer of the many layers of the horizontal blade rotor, and provides the horizontal blade rotor having the eight horizontal blades as FIG. 6 and having be mounted coaxially with the very long shaft FIG. 2 No. 2. The very wide & high octagon steel bar base frame also comprise a torsions promotion and one-way rotation device FIG. 10 No. 76,77,78,79,80,81,82,83 purposing as that of the torsions promotion and one-way rotation device FIG. 1 No. 24,25,26, 27, a rotational speed and controlling device (for example FIG. 10 No. 84,85,86,87,88,89,90,91) purposing as that of the rotational speed controlling device FIG. 1 No. 28,29,30,31, several or more layers (separateds) subsidiary frames (for example FIGS. 10, 11 No. 92,93,94,95) as that of the joining subsidiary frame FIG. 3 No. 32E, 32F,32G respectively separated inside the very wide & high octagon steel bar base frame and to make the very wide & high octagon steel bar base frame to into several or more layers (separateds), several or more layers bearing devices as that of the two or more bearing devices FIG. 2 No. 3,4,5,5A,5B, several or more layers of a work station as that of the work stations FIG. 2 No. 35,35A,35B,35C respectively attached on each of the two or more bearing devices, an engine room FIG. 11 No. 96 as that of the engine room FIG. 3 No. 32D, and several or more layers of a staircase as that of the several or more steps of the staircase FIG. 2 No. 38A,38B,38C,38D,38E etc.

The present invention is no require to distinguish the direction of the wind, because the each door of the each layer of the wide base frame are opening as obove, so can allow the wind to blow the many horizontal blade rotors and not limit the wind is come from any direction, especially is when the wide base frame is replaced by the very wide & high octagon steel bar base frame FIG. 10 No. 1, FIG. 11 having the eight very wide opening sides allowing the wind to blow the many the horizontal blade rotors and is further not limit the wind is come from any direction.

The present invention it on apply includes another type made into a movable or fixed-type small-sized applying at any palces which are mounted on inclueing an upper portion of a big storied buliding or are laid at other any places.

The present invention is another able to provide any necessary power requiring only the power which are the torsionss & rotational speed and requiring not need the electricitys, for example, to provide the power to drive a pump to pump waters, especially applys to pump the sea waters to provide producing the fresh waters.

### FUNCTION OF THE INVENTION

The present invention it definited be tested and able to start at the breeze about 1.5 m/s and no require at 3-4 m/s as the current wind energy. The present invention further is able to generate a larger torsions than that of the current wind energy and able to generate a larger power or electricity than that of the current wind energy. The functions of the present invention as above are due to it withs below characterizeds comprising: 1. the each horizontal blade is not only able to overall to face to the wind and able to overall and directly to be blown by the wide and not indirectly to be blown by the wind from an askew side as that of the current wind energy. 2. the many horizonal blade rotors are together to face to the wind so able to be blown by manifold even more wide areas and able to surpass the current wind energy to manifold. 3. the resistance reduction and torsion strengthen device is able to reduce the resistance of the wind when each of the many horizontal blade rotors is rotation. 4. the torsions promotion device able to reduce an offsetting force if the relative two sides which namely the diameter of the each horizontal blade rotor are together to be blown by the wind etc., so it not only able to generate the larger torsions, but also able to generate a larger at manifold than that of the current wind energy when its size is expanded to an extent, for example to expand the length of the each horizontal blade and to expand the width & height especially is to expand the width of the wide base frame FIG. 3 or FIG. 11. Particular is only to expand the width of the wide base frame and not need to expand the height of the wide base frame and is to expand the width of the wide base frame to furthermore width which same as the necessary ground area including a necessary separated kept at between each of the current wind energy, or for example to expand and to combine its identical two or more quantitys and to together generating a more great quantitys of power or electricitys, thus it builded is can uncertain on a coast or sea and can only to be builded on an appropriate wide & airiness place and can no requiring the great high tower and great blade rotor total at about 100 meters as that of the current wind energy. Another, due to the rotational speed controlling device so enable the many horizontal blade rotors to continuous rotating and to continuous generating the power or electricity when the wind speed is exceed the certain extent or when the typhoon is happened.

The field also same of the present invention, if the wide base frame FIG. 3 is builed formed by a wide & high polygonal or trianangular steel bar base frame.

The field also same of the present invention, if the very long shaft FIG. 2 No. 2 is replaced by two short rotatable shafts. The two rotatable shafts are respectively be installed by a bearing device which is installed at a lower and upper portion of the central portion of the wide base frame or installed at a lower and upper portion of the central portion of the very wide & high hollow interior, and respectively provide for coaxially installing with the many horizontal blade rotor.

The field also same of the present invention, if the each horizontal blade is made into a shaped seem an arc as FIG. 8.

The field also same of the present invention, if the each horizontal blade be made into a shaped seem an erect-type strip blade then to be combined formed the erect-type rectangle blade or a wall-type blade FIG. 12 No. 20B shaped seem a wide & high wall.

The field also same of the present invention, if the each rectangle plastic planking and the each erect-type rectangle frame FIG. 4 No. 63A are respectively be changed its the erect-type to become an inclined-type slightly incline and to become an erect but slight inclined rectangle blade.

The field also same of the present invention, if the present a wall-type blade FIG. 12 No. 20B shaped seem a wide & high wall.

invention is combined its same two or more quantitys then to together generating a more great quantity of powers or electricitys.

Having now fully explained the present invention as to its purpose, its construction and its use, it will be evident that the same is susceptible to numerous variations without departing from the spirit thereof, and accordingly, attention is now directed to the appended claims to ascertain the actual scope of the same.

I claims:

1. A power generator generating a power by the force of wind, its constitute comprising:
a wide & high base frame having a wide & high hollow interior and many wide opening sides which are namely a wide opening periphery allowing the said wind to blow into to the said wide & high hollow interior,
two rotatable shafts respectively be installed by a bearing device which is installed at a lower and upper portion of the said wide & high base frame or installed at a lower and upper portion of the said wide & high hollow interior,
a horizontal-type blade rotor formed comprises several or more horizontal & erect-type rectangle blades respectively seem a rectangle and respectively applys to overall face to and not side to face to the said wind and to be blown by the said wind and to make the said horizontal-type blade rotor to rotate to generate a power, and formed to rotate by a horizontal-type, and formed coaxially with the said two rotatable shafts,
a power transmition device applying transmit a power come from the horizontal-type blade rotor when the said several or more horinontal & erect-type rectangle blades are respectively to be blown by the said wind, whereby the said power transmition device is able to transmit out the said power when the said wind is respectively blow each of the said several or more horizontal & erect-type rectangle blades.

2. A power generator generating a power by the force of wind, its constitute comprising:
a wide & high base frame which comprises a wide & high hollow interior, many wide opening sides which are namely a wide opening periphery allowing the said wind to blow into to the said wide & high hollow interior, and two or more bearing frames respectively be separated installed at between a lower and upper portion of the said wide & high base frame or installed at between a lower and upper portion of the said wide & high hollow interior,
two or more bearing devices respectively be installed at the said two or more bearing frames,
a long shaft installed by the said two or more bearing devices,
a horizontal-type blade rotor formed comprises several or more horizontal & erect-type rectangle blades respectively seem a rectangle and respectively applys to overall face to and not side to face to the said wind and to be blown by the said wind and to make the said horizontal-type blade rotor to rotate to generate a power, and formed to rotate by a horizontal-type, and formed coaxially with the said long shaft, and
a power transmition device applying transmit a power come from the horizontal-type blade rotor when the said several or more horinontal & erect-type rectangle blades are respectively to be blown by the said wind, whereby the said power transmition device is able to transmit out the said power when the said wind is respectively blow each of the said several or more horizontal & erect-type rectangle blades.

3. The power generator as claimed in claim 1 or 2, further comprises an electrical generator actuated by the said power and to generate an electricity.

4. The power generator as claimed in claim 1 or 2, wherein the said wide & high base frame further is its height be separated to into several or more layers.

5. The power generator as claimed in claim 1 or 2 or 4, wherein the said wide & high base frame is a wide & high steel bar like that of a big storied building.

6. The power generator as claimed in claim 1 or 2 or 4 or 5, wherein the said wide & high base frame further is builded into a structure seem a wide & high octagon or square or polygon or circular structure.

7. The power generator as claimed in claim 4, wherein the several or more layers are respectively formed by several or more joining subsidiary frames which are respectively have a central square frame and respectively formed by several or more cross beams mutualy cross, and respectively to join with several sections of a periphery of the said certain wide & high base frame and to distribute at between a lower and upper portion of the said wide & high base frame and to make a wide & high hollow interior of the said wide & high base frame to be separated to into the said several or more layers, thereby to enhance a strong structure of the said wide & high base frame and to respectively providing for joining a bearing device.

8. The power generator as claimed in claim 1 or 2, wherein the said many wide opening sides are respectively can be opened or closed to an extent.

9. The power generator as claimed in claim 2, wherein the said bearing devices are comprise one or more ball collar thrust bearing which namely a plane bearing applying to bear a thrust of the said long shaft and to stabilize the said long shaft.

10. The power generator as claimed in claim 2, wherein the said long shaft is connected formed by several or more sections of a short piping member having a flange on each of its two ends and several holes on the said flange and by several or more connecting hub members having several or more connectors arranged formed a cross or spokewise shaped, and by several bolts respectively through the said several holes.

11. The power generator as claimed in claim 10, wherein the said several or more sections are respectively connected with several or more thick connectors which are respectively connected at between each of the said several or more sections and are respectively connected extended from the said connecting hub member and together arrange form a horizontal cross or spokewise shaped, thereby to provide connecting the said several or more horizontal & erect-type rectangle blades as claimed in the claim 1 or 2.

12. The power generator as claimed in claim 1, wherein the said two rotatable shafts further are an under one of the said two shafts is its under ender portion be mounted on an erect frame and be kept at an appropriate distance with a surface of a foundation of the said wide & high base frame, thereby to provide mounting a group of a bevel wheel/gear to transmit out the said power.

13. The power generator as claimed in claim 2, wherein the said long shaft further is its under ender portion be mounted on an erect frame and be kept at an appropriate distance with a surface of a foundation of the said wide & high base frame, thereby to provide mounting a group of a bevel wheel/gear to transmit out the said power.

14. The power generator as claimed in claim 2 or 13, wherein the said long shaft further is its uuder end portion be supported by a ball collar thrust bearing which namely a plane bearing.

15. The power generator as claimed in claim 1 or 2, further comprises sever or more the said horizontal-type balde rotors and which are arranged combined to form several or more layers at between the said lower and upper portion of the said wide & high hollow interior and are arranged from the said lower to upper portion of the said wide & high hollow interior then to from the said several or more layers.

16. The power generator as claimed in claim 1 or 2, wherein the said several or more horizontal & erect-type rectangle blades are arranged formed the horizontal-type blade rotor by a horizontal-type cross or spokewise shaped.

17. The power generator as claimed in claim 1 or 2, wherein the said several or more horizontal & erect-type rectangle blades are respectively formed comprise a horizontal & erect-type rectangle or strip blade member which is arranged fromed align from lateral arranged, a horizontal & erect-type rectangle or strip frame applying installing the said horizontal & erect-type rectangle or strip blade member.

18. The power generator as claimed in claim 1 or 2, wherein the said several or more horizontal & erect-type rectangle blades are respectively be replaced by a wall-type blade shaped seem a wide & high wall.

19. The power generator as claimed in claim 17, wherein the said said several or more horizontal & erect-type rectangle or strip blade members are respectively formed comprise an upper and under long L-shaped cross beams, and many smaller combining members respectively applying to separate and together to connect the said upper and under long L-shaped cross beams shaped like an angle steel then to form the said horizontal & erect-type rectangle or strip frame applying installing the said horizontal & erect-type rectangle frame.

20. The power generator as claimed in claim 17 or 19, wherein the said several or more horizontal & erect-type rectangle or strip blade members further are respectively be fixed by a way inclinable backward turn, thereby to inclined backward turn up from an under side of each of the said several or more horizontal & erect-type rectangle or strip blade members when the said each horizontal & erect-type rectangle or strip blade member is blown by the wind and to actuate the said horizontal-type blade rotor to rotate and when after the said each horizontal & erect-type rectangle or strip blade member is not to be blown by the said wind and is on return its original place and is to against the said wind.

21. The power generator as claimed in claim 1 or 2, wherein the said several or more horizontal & erect-type rectangle blades are respectively changed its the said erect-type to become an inclined-type.

22. The power generator as claimed in claim 17 or 19, wherein the said sereral or more horizontal & erect-type strip blade members are respectively changed its the said erect-type to become an inclined-type.

23. The power generator as claimed in claim 18, wherein the said wall-type blade is shaped seem an inclined wall.

24. The power generator as claimed in claim 1 or 2 or 17, wherein several or more horizontal & erect-type rectangle blades are respectively made into a shaped seem an arc.

25. The power generator as claimed in claim 18, wherein said wall-type blade is made into a shaped seem an arc.

26. The power generator as claimed in claim 1 or 2 or 16 or 17 or 18 or 19 or 20 or 21 or 22 wherein the said several or more horizontal & erect-type rectangle blades further are respectively comprises a backward awry at its outward end portion.

27. The power generator as claimed in claim 17 or 19 or 20 or 22, wherein the said several or more horizontal & erect-type strip blades are respectively further comprises a backward awry at its outward end portion.

28. The power generator as claimed in claim 1 or 2, wherein the said wide opening sides are respectively be covered to retain only an opining extent restricting the siad wind to blown the said horizontal-type blade rotor is only blow to about ½ of a diameter of the said horizontal-type blade rotor, thereby to reduce an offsetting force generating at if two sides/diameter of the said horizontal-typen blade rotor are together be blown by the said wind and thereby to restrict the said horizontal-type blade rotor to rotatie is only one-way rotation.

29. The power generator as claimed in claim 1 or 2, wherein the said wide & high base frame is builded stabled on a stable foundation having two or more layers of a wide & thick weight.

30. The power generator as claimed in claim 29, wherein the said two or more layers of the said wide & thick weight are respectively bulided formed comprise many H-shaped steel bars and thick steel sheets.

31. The power generator as claimed in claim 29, wherein the said two two or more layers of the said wide & thick weight are respectively bulided formed by a reinforced concrete.

32. The power generator as claimed in claim 29 or 30 or 31, wherein the said two or more layers of the said wide & thick weight are further be infilled an original sandy soils dug up at before buliding the said stable frondation to between the said two or to between each of the said more layers and to make the said stable frondation to become more weigh.

33. The power generator as claimed in claim 1 or 2 or 3, furthermore is combined its same two or more quantitys then to together generating more great quantity of powers or electricitys.

34. The power generator as claimed in claim 1 or 2 or 3, on apply is made into a movable or fixed small-sized applying at any palces which are mounted on inclueing an upper portion of a big storied buliding or are laid at other any place.

35. The power generator as claimed in claim 4, wherein the said several or more layers are respectively be attached a work station.

36. The power generator as claimed in claim 1 or 2 or 4 or 5 or 6 or 7 or 29, wherein the said wide & high base frame further comprises several or more steps of a staircase on its outside so as to respectively to provide for a worker to reach the said work station as claimed claim 35.
